(19) United States
(12) Patent Application Publication
(10) Pub. No.: US 2021/0221013 A1
(43) Pub. Date: Jul. 22, 2021

(54) EXTENDABLE BACK AND BODY GROOMER

(71) Applicant: Bearback, LLC, Milton, GA (US)

(72) Inventor: JP Duvall, Milton, GA (US)

(73) Assignee: Bearback, LLC, Milton, GA (US)

(21) Appl. No.: 16/746,669

(22) Filed: Jan. 17, 2020

(51) Int. Cl. B26B 21/52; B26B 21/40; B26B 21/22

(52) U.S. Cl. CPC B26B 21/523; B26B 21/22; B26B 21/521; B26B 21/4018

(57) ABSTRACT

The present disclosure is a device for shaving hair. The device has a handle and a shaft pivotably coupled to the handle and terminating with a head. Further, the device has a lower cover fixedly coupled to the head and the lower cover has a first magnet. The lower cover receives at least one razor blade and magnetically retains the razor blade via the first magnet.

### BACKGROUND

Some individuals grow hair in unwanted places on their bodies. One such place is an individual's back. When an individual grows hair on his back, it is difficult to remove the hair because the individual's back is difficult, if not impossible, to reach with a conventional razor blade.

Some individuals use a wax removal procedure. The wax removal procedure may be done in the comfort of the individual's home, but this requires a partner. Often the individual goes to a salon where the wax procedure is performed. This may be uncomfortable for some individuals.

Some extendable back razors have an extendable shaft that allows the individual to shave his or her back easier. Some extendable back razors have a shaft terminating with a head to which a removeable cartridge is coupled. The cartridge contains the razors that are used to remove the hair. These cartridges are replaced after some time of use. This is inefficient and the cartridges are often expensive relative to the extendable back razor cost.

Some extendable back razors have an extendable shaft terminating with a razor housing. The razors are secured within the razor housing via screws. This results in an arduous process of removing the screws to replace the razors after a period of use.

### BRIEF DESCRIPTION OF THE FIGURES

The present disclosure can be better understood with reference to the following figures. The elements of the figures are not necessarily to scale relative to each other, emphasis instead being placed upon clearly illustrating the principles of the disclosure. Furthermore, like reference numerals designate corresponding parts throughout the several views.

FIG. 1 is an exploded view of an exemplary extendable back and body groomer in accordance with an embodiment of the present disclosure.

FIG. 2 is a top plan view of the extendable back and body groomer of FIG. 1 in an extended position.

FIG. 3 is a top view of the extendable back and body groomer of FIG. 1 in a folded position.

FIG. 4 is a bottom view of the extendable back and body groomer of FIG. 1 in an extended position.

FIG. 5 is a perspective view of a head of the extended back razor of FIG. 1 coupled to a plurality of razor components and a hand actuating tabs of the top cover of the extended back razor to remove the top cover to expose conventional razors for removal.

FIG. 6 is a perspective view of the head of the extended back razor of FIG. 1 with the top cover removed.

FIG. 7 is a perspective view of the head of the extended back razor of FIG. 1 showing a hand removing a razor from an intermediate plate.

FIG. 8 is a perspective view of the head of the extended back razor of FIG. 1 showing a hand beginning to remove a razor from the intermediate plate.

FIG. 9 is a perspective view of the head of the extended back razor of FIG. 1 wherein the intermediate plate is rotated upward and showing a hand beginning to remove a razor blade from a lower cover.

FIG. 10 is a back view of an individual using the extendable back and body groomer of FIG. 1 to shave his back.

FIG. 11 is a front view of an individual using the extendable back and body groomer of FIG. 1 to shave his chest.

### DETAILED DESCRIPTION

The present disclosure describes an exemplary extendable back and body groomer in accordance with an embodiment of the present disclosure. The extendable back and body groomer comprises a handle that is hingedly coupled to a shaft. The shaft terminates with a substantially rectangular head. Coupled to the rectangular head is a razor blade housing. The razor blade housing comprises a top cover, an intermediate plate, and a lower cover. The lower cover couples to the substantially rectangular head.

On a top side of the lower cover are guides, protrusions, and magnets. In one embodiment, the lower cover is configured to receive two bottom conventional razor blades on the guides and the protrusions. The magnets secure the razor blades to the lower cover.

The lower cover is pivotably coupled to the intermediate plate so that the intermediate plate may be actuated to change the bottom two conventional razor blades after a period of use. The intermediate place comprises a guard for separating the hair and to protect a user from direct contact with the razor blades coupled to the lower cover.

The intermediate plate also comprises guides, protrusions, and magnets. In one embodiment, the intermediate plate is configured to receive two top conventional razor blades on the guides and the protrusions. The magnets secure the razor blades to the intermediate plate.

The intermediate plate is fixedly coupled to a top cover. The top cover covers the two conventional razor blades. Further, an edge of the top cover comprises a guard that separates hair and protects the user when the extendable back and body groomer is in use. The top cover comprises a tab on each end that releasably couple with the intermediate place.

Thus, when the conventional razor blades begin to dull after a period of use, the razor blades are easily changeable. The top cover is removed by actuation of the tabs to expose the top two conventional razor blades. When exposed, the top two conventional razor blades are exposed for removal. The intermediate plate is opened by applying pressure to an edge of the intermediate place, and when pressure is applied to a grooved indentation or thumbnail slot, the intermediate plate pivotably opens exposing the bottom two conventional razor blades.

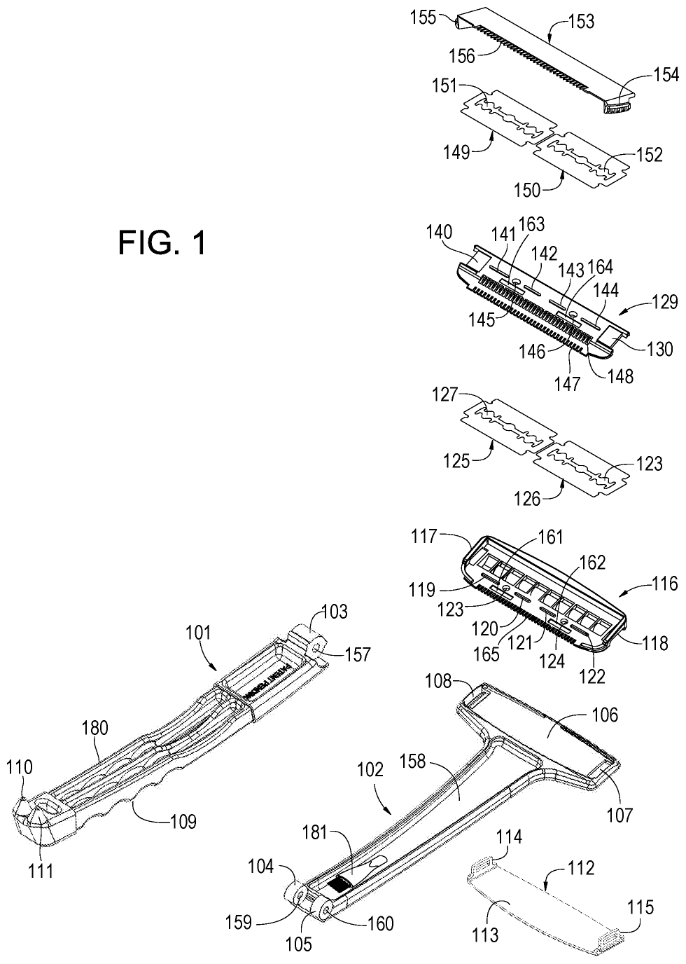

FIG. 1 is an exploded view of an exemplary extendable back and body groomer 100 in accordance with an embodiment of the present disclosure. The extendable back and body groomer 100 comprises a handle 101 and a shaft 102 terminating in a substantially rectangular head 106.

The handle 101 comprises a shaft 180. The shaft 180 comprises a scalloped grip 109 for grasping the extendable back and body groomer 100 for use. The handle 101 comprises a hinge receptacle 103. The hinge receptacle 103 is substantially cylindrical and comprises an opening 103 extending laterally through the hinge receptacle 103 for receiving a coupling implement, e.g., a metal rod. On an opposing end are conical protrusions 110, 111. The conical protrusions 110, 111 may be used for scratching one's back or providing targeted pressure point relief.

The head implement 102 comprises a shaft 158. On a coupling end of the shaft 158 are two cylindrical hinge receptacles 104 and 105. The hinge receptacle 103 fits between the hinge receptacles 104 and 105, and a fastener is inserted in the openings 160, 157, and 159 thereby securing the handle 101 to the head implement 102.

The head implement 102 further comprises a brush 181 constructed for cleaning the extendable back and body groomer 100. The brush 181 comprises a magnet (not shown). Also, the head implement 102 comprises a magnet (not shown). The magnet on the brush 181 is magnetically retained by the magnet on the head implement 102.

The substantially rectangular head 106 comprises on each end an opening 107, 108. The openings 107, 108 are substantially rectangular. The openings 107, 108 are for receiving tabs for coupling razor implements to the substantially rectangular head 106.

The extendable back and body groomer 100 further comprises a logo plate 112. The logo plate 112 comprises a substantially rectangular panel 113. A logo may be inscribed or otherwise placed on the panel 113. Disposed on each end of the panel 113 is a tab 114, 115. The tabs 114, 115 are inserted through openings 108, 107 respectively to coupled to logo plate 112 to the head 106. The logo plate 112 is coupled to a top surface of the head 106.

The extendable back and body groomer 100 further comprises a lower cover 116. The lower cover 116 comprises protrusions 117, 118 disposed at right angles on each end of the lower cover 116. The protrusions 117, 118 are inserted in the openings 108, 107, respectively, to couple the lower cover 116 to the substantially rectangular head 106.

The lower cover 116 further comprises rectangular protrusions 119-122 and cylindrical protrusions 123, 124. The protrusions are for receiving two bottom conventional razor blades 125, 126. In this regard, the two bottom conventional razor blades 125, 126 comprise slits 127, 128 through which the protrusions 119-124 are inserted. The lower cover 116 comprises magnets 161, 162. When the protrusions 119-124 are inserted in the slits 127, 128, the magnets 161, 162 couple to the razor blades 125, 126 holding the razor blades 125, 126 securely in place for use.

The lower cover 116 further comprises a lateral, horizontally extending guard 165 disposed on a front edge of the lower cover 116. The lateral, horizontally extending guard 165 acts as a barrier protecting the user from the sharp edges of the razor blades 125, 126.

The intermediate plate 129 is substantially rectangular. The intermediate plate 129 comprises rectangular protrusions 141-144 and cylindrical protrusions 145, 146. The protrusions 141-146 are for receiving two top conventional razor blades 149, 150. In this regard, the two top conventional razor blades 149, 150 comprise slits 151, 152 through which the protrusions 141-146 are inserted. The intermediate plate 129 comprises magnets 163, 164. When the protrusions 141-146 are inserted in the slits 151, 152, the magnets 163, 164 couple to the razor blades 149, 150 holding the razor blades 149, 150 securely in place for use.

The intermediate plate 129 further comprises a lateral, horizontally extending guard 148 disposed toward a front edge of the intermediate plate 129. The lateral, horizontally extending guard 148 comprises a plurality of teeth that protect the user's skin when the extendable back and body groomer 100 is in use.

The intermediate plate 129 further comprises a lateral, horizontally extending guard 147 disposed on the front edge of the intermediate plate 129. The guard 147 acts as a barrier protecting the user from the sharp edges of the razor blades 149, 150.

The intermediate plate 129 further comprises a substantially rectangular indentation 130, 140 on each end of the intermediate plate 129. When razor blades 149, 150 are installed on the intermediate plate 129, the indentations 130, 140 are exposed when the top cover 153 is removed. If the user desires to remove the razor blades 149, 150, to install new razor blades (not shown), the user places his finger on the indentation and applies upward pressure on the razor blades 149, 150 to remove them from the intermediate plate 129.

The extendable back and body groomer 100 further comprises the top cover 153. The top cover 153 is substantially rectangular and covers the razor blades 149, 150. Disposed on each end of the substantially rectangular top cover 153 is respective tabs 154, 155. The tabs 154, 155 extend at a right angle from a top of the top cover 153. The tabs 154, 155 are flexible. The tabs 154, 155 couple the top cover 153 to the openings 107, 108 of the head 106 of the shaft 102. When the user desires to remove the top cover 153 from the intermediate plate 129, the user squeezes inward on the tabs 154, 155 thereby releasing the top cover 153 from the intermediate plate 129.

The top cover 153 further comprises a lateral, horizontally extending guard 156 disposed on a front edge of the top cover 153. The lateral, horizontally extending guard 156 comprises a plurality of teeth that protect the user's skin while the extendable back and body groomer 100 is in use.

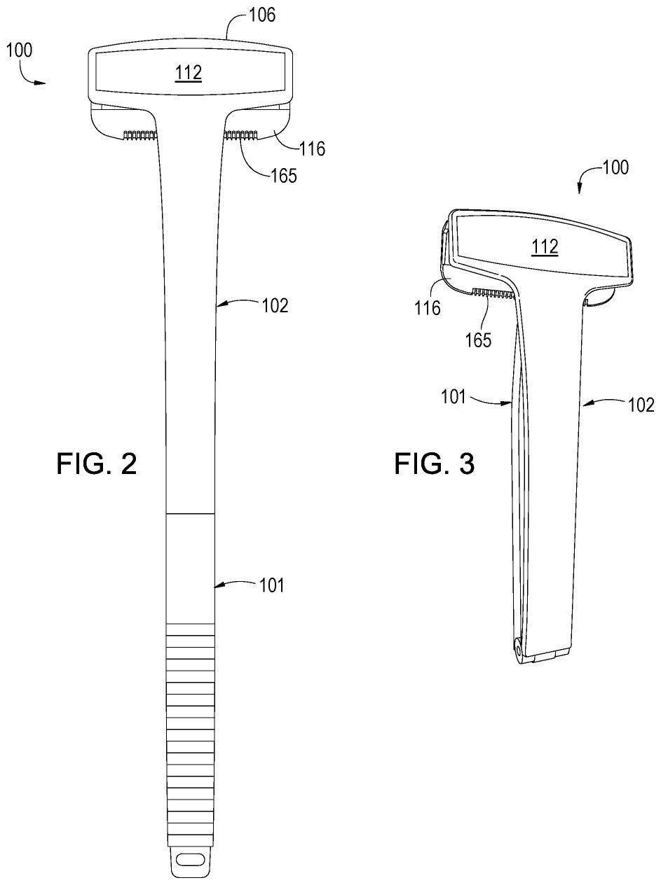

FIG. 2 is a top plan view of the extendable back and body groomer 100 in an extended position. The extendable back and body groomer 100 comprises the handle 101 and the shaft 102 that terminates with a substantially rectangular head 106.

The logo plate 112 is coupled to the top side of the head 106. Further, the razor components, including the top cover 153 (FIG. 1), the intermediate plate 129 (FIG. 1), and the lower cover 116, are coupled to the razor head 106. The extendable back and body groomer 100 is positioned and ready for use, and the guard protects the user from the razor blades installed in the razor components 153, 129, and 116.

FIG. 3 is a top view of the extendable back and body groomer 100 in a folded position. In a folded position, the handle 101 rests adjacent the shaft 102. The razor components, including the top cover 153 (FIG. 1), the intermediate plate 129 (FIG. 1), and the lower cover 116 with the guard exposed, are coupled to the razor head 106. The extendable back and body groomer 100 is positioned for storage.

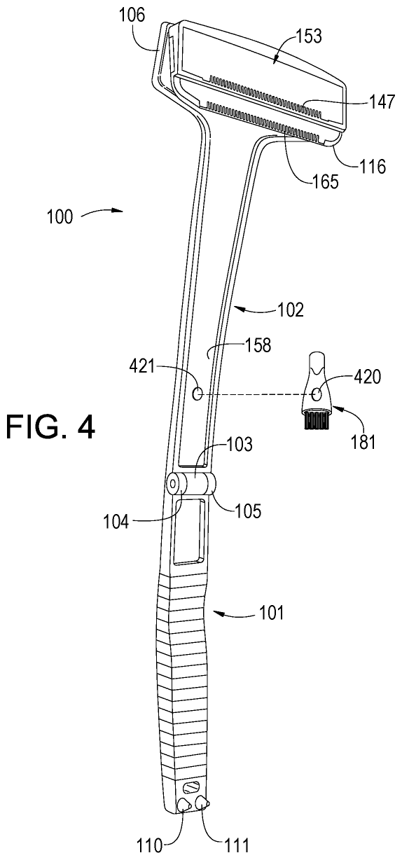

FIG. 4 is a bottom view of the extendable back and body groomer 100 in an extended position. That is, the handle 101 is rotated away from the shaft 102 via the hinge receptacles 103-105. In its extended position, the extendable back and body groomer 100 is ready for use.

In this regard, coupled to the head 106 are the lower cover 116, the intermediate plate 129 (FIG. 1), and the top cover 153. The razor blades 125 (FIG. 1) and 126 (FIG. 1) are installed on the lower cover 116 and the razor blades 149 (FIG. 1) and 150 (FIG. 1) are installed on the intermediate plate 129. The guard 165 on the lower cover 116 and the guard 156 on the top cover 153 are exposed.

The user can grasp the handle 101 and lifting the extendable back and body groomer 100 over his head can shave his back. As the extendable back and body groomer 100 is moved over the user's skin, the guard 156 and guard 165 comprise a plurality of teeth that protect the user's skin, and the razors 125, 126, 149, 150 smoothly cut the hair from the user's back.

Further, handle 101 comprises the conical protrusions 110, 111. The conical protrusions 110, 111 may be used for scratching one's back or providing targeted pressure point relief.

The brush 181 is shown removed from the head implement 102. The brush 181 may be removed in order to clean the extendable back and body groomer 100. The brush comprises the magnet 420, which can be coupled to the brush via an epoxy. The head implement also comprises a magnet 421. When the user finishes cleaning the extendable back and body groomer 100, the user can place the brush in the head implement 102 by coupling the brush magnet 420 with the implement head magnet 421.

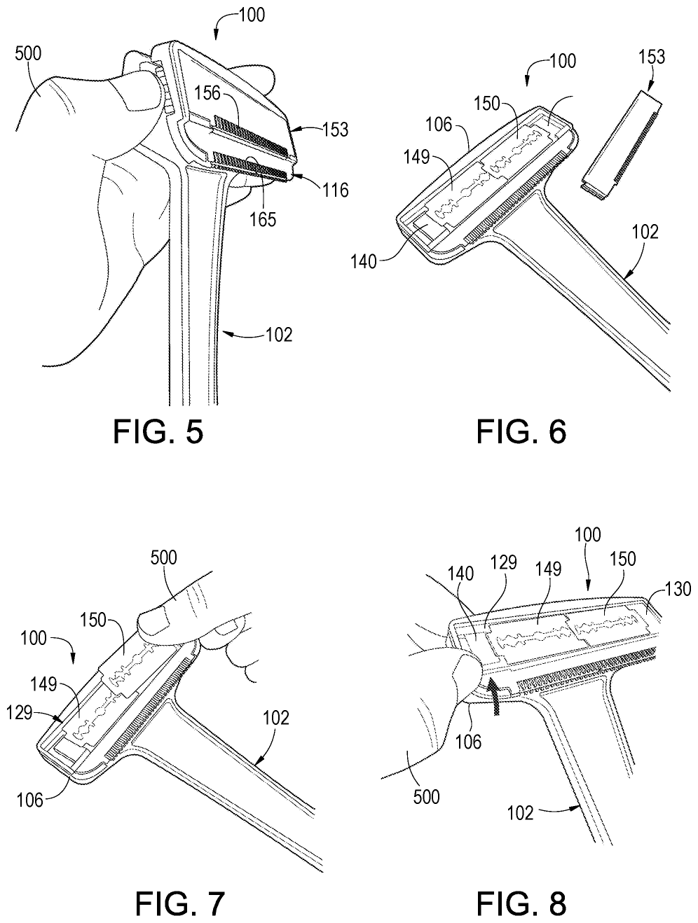

FIG. 5 is a perspective view of a head 106 of the extendable back and body groomer 100 coupled to a plurality of razor components and a hand 500 actuating tabs of the top cover 153 of the extendable back and body groomer 100 to remove the top cover 153 to expose the conventional razors 149 (FIG. 1) and 150 (FIG. 1) for removal. In this regard, the hand 500 squeezes the tabs inwardly, which decouples the top cover 153. Note that the top cover 153 comprises a guard 156 and the lower cover 116 comprises a guard 165 that protect the user from the razor blades 149, 150.

FIG. 6 is a perspective view of the head 106 of the extendable back and body groomer 100 with the top cover 153 removed. When the top cover 153 is removed the razor blades 149, 150 are exposed. The indentations 140, 130 allow the user to remove the razor blades 149, 150.

FIG. 7 is a perspective view of the head 106 of the shaft 102 of the extendable back and body groomer 100. The hand 500 is in the process of removing a razor blade 150 from the intermediate plate 129. In this regard, the user presses upward on the razor blade 150 from the indentation 130 (FIG. 6).

FIG. 8 is a perspective view of the head 106 of the shaft 102 of the extendable back and body groomer 100 showing the hand 500 beginning to remove the razor blade 149 from the intermediate plate 129. In this regard, the user places his finger on the indentation 140 allowing him to access underneath the razor blade 149. He then lifts upward, and the razor blade 149 pops out.

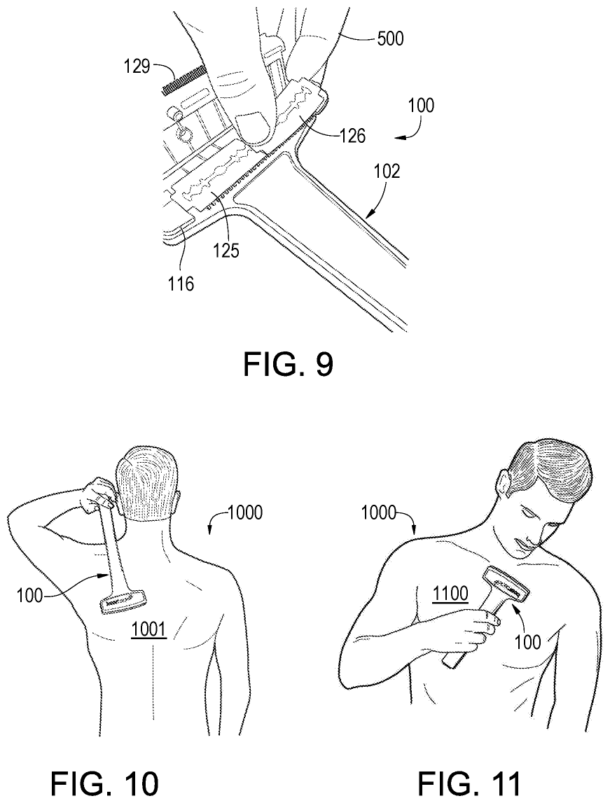

FIG. 9 is a perspective view of the head 106 of the shaft 102 of the extendable back and body groomer 100 wherein the intermediate plate 129 is hingedly rotated upward. When the intermediate plate 129 is hingedly rotated upward, the razor blades 125, 126 are exposed. The user may remove a razor blade with his hand 500 from the lower cover 116, as shown.

FIG. 10 is a back view of an individual 1000 using the extendable back and body groomer 100 to shave his back 1001. The user lifts the extendable back and body groomer 100 over his head and applies pressure to his back and moves the extendable back and body groomer 100. The razor blades 125, 126, 149, 150 cut the hair on the user's back and the guards 165 (FIG. 1), 147 (FIG. 1), 148 (FIG. 1), 156 (FIG. 1) protect the user's skin as the user shaves his back.

FIG. 11 is a front view of an individual 1100 using the extendable back and body groomer 100 to shave his chest 1100. In such an embodiment, the user can remove the handle 101 (FIG. 1) from the shaft 102 (FIG. 1). This allows the user easier access to his chest 1100 for shaving.

What I claim is:

1. A device for shaving hair, the device comprising:
a handle;
a shaft pivotably coupled to the handle and terminating with a head; and
a lower cover fixedly coupled to the head and comprising a first magnet, the lower cover is configured for receiving at least one razor blade and magnetically retaining the razor blade via the first magnet.

2. The device for shaving hair of claim 1 wherein the head is substantially rectangular.

3. The device for shaving hair of claim 1, further comprising an intermediate plate that is situated atop the first magnet.

4. The device for shaving hair of claim 3, wherein the intermediate plate is hingedly coupled to the lower cover such that the cover can be lifted exposing the at least one razor blade.

5. The device for shaving hair of claim 4, wherein the intermediate plate is configured for receiving at least one razor blade on a top surface.

6. The device for shaving hair of claim 5, wherein the intermediate plate is configured for magnetically retaining the at least one razor blade via a second magnet.

7. The device for shaving hair of claim 6, further comprising a top cover.

8. The device for shaving hair of claim 7, wherein the top cover is removably coupled to the intermediate plate.

9. The device for shaving hair of claim 8, wherein the top cover comprises flexible tabs extending perpendicular to the top surface of the top cover.

10. The device for shaving hair of claim 9, wherein the flexible tabs are configured to release the top cover from the intermediate plate when the tabs are squeezed.

11. The device of claim 10, wherein the lower cover comprises a guard on a first front edge.

12. The device of claim 11, wherein the intermediate plated comprises at least one guard on a second front edge.

13. The device of claim 12, wherein the top cover comprises at least one guard on a third front edge.

14. A device for shaving hair, the device comprising:
a handle;
a shaft pivotably coupled to the handle and terminating with a head; and
a lower cover fixedly coupled to the head and comprising two magnets, the lower cover configured for receiving first two razor blades and magnetically retaining the two razor blades via the two magnets.

15. The device for shaving hair of claim 14, further comprising an intermediate plate hingedly coupled to the lower cover and a top cover removably coupled to the intermediate plate.

16. The device for shaving hair of claim 15, wherein the first two razor blades are installed between the lower cover and the intermediate plate.

17. The device for shaving hair of claim 16, further comprising second two razor blades and the second two razor blades are installed between the intermediate plate and the top cover.

18. The device for shaving hair of claim 17, wherein the top cover comprises a first tab extending downwardly on one end and a second tab extending downwardly on a second end and the first tab and the second tab couple the top cover to the head.

19. The device for shaving hair of claim 18, wherein the tabs are flexible.

20. The device for shaving hair of claim 19, wherein when the flexible tabs are squeezed, the top cover releases from the intermediate plate.
